(19) United States
(12) Patent Application Publication
(10) Pub. No.: US 2026/0135709 A1
(43) Pub. Date: May 14, 2026

(54) CREDENTIAL MANAGEMENT SYSTEM AND RELATED METHODS

(71) Applicant: Lucky Badger LLC, Olympia, WA (US)

(72) Inventors: Melanie Asher, Olympia, WA (US); Valerie Cobb, Post Falls, ID (US)

(73) Assignee: Lucky Badger LLC, Olympia, WA (US)

(21) Appl. No.: 19/385,410

(22) Filed: Nov. 11, 2025

Related U.S. Application Data
(60) Provisional application No. 63/719,278, filed on Nov. 12, 2024.

(51) Int. Cl. H04L 9/32

(52) U.S. Cl. CPC H04L 9/3213; H04L 9/3247

(57) ABSTRACT

Implementations of credential management methods may include receiving, from a credential-defining organization, a criteria corresponding with a credential. The method may include continually monitoring, through a monitoring module, the recipient organization according to a set of monitored organization actions associated with the criteria. The method may include generating, through a status token module, a credential status token. The method may include generating, through a compliance module, a digital compliance indicator corresponding to the credential status token. The digital compliance indicator may include either a compliance status with a compliance indicator operatively associated therewith or a non-compliance status with a non-compliance indicator operatively associated therewith. The method may include storing the credential status token and the digital compliance indicator in a credential wallet configured to automatically and in real-time synchronize with a digital display. The monitored organization may be dynamically and authoritatively monitored for adherence to the criteria.

### CROSS REFERENCE TO RELATED APPLICATIONS

This document claims the benefit of the filing date of U.S. Provisional Patent Application 63/719,278, entitled “Real-Time Compliance Notification System and Method” to Asher et. al. which was filed on November 12, 2024, the disclosure of which is hereby incorporated entirely herein by reference.

### BACKGROUND

### 1. Technical Field

Aspects of this document relate generally to credential management systems and methods. More specific implementations involve real-time credential management systems and methods.

### 2. Background

Digital badges are used in various fields, such as education, corporate training, professional certification, and event management. These badges serve as a visual and digital representation of earned skills, participation, and accomplishments. For instance, in corporate and organizational environments, digital badges offer an efficient method to acknowledge employees' achievements, tenure, or specialized skills.

### SUMMARY

Implementations of credential management methods may include receiving, from a credential-defining organization, through a credential information module, a criteria corresponding with a credential. The method may include receiving, from a credential-defining organization, through a credential information module, an identity of an issuing organization associated with the credential. The method may include receiving, at an issuance module, from the issuing organization, an identity of a recipient organization associated with the credential. The method may include continually monitoring, through a monitoring module, the recipient organization according to a set of monitored organization actions associated with the criteria. The method may include generating, through a status token module, a credential status token. The method may include generating, through a compliance module, a digital compliance indicator corresponding to the credential status token. The digital compliance indicator may include either a compliance status with a compliance indicator operatively associated therewith or a non-compliance status with a non-compliance indicator operatively associated therewith. The method may include storing the credential status token and the digital compliance indicator in a credential wallet configured to automatically and in real-time synchronize with a digital display. The method may include transmitting, through a transmission module, a credential status notification in real-time to the receiving organization. The method may include, in real-time, updating, via compliance module, the digital display with a digital-compliance indicator. Upon failure of the recipient organization to adhere to the criteria, the method may include automatically replacing the compliance status with the non-compliant status on the digital display. The method may include locking, through the compliance module, the digital-compliance indicator to an issuer-controlled verification key. The method may include revoking, through the status token module, the credential status token upon detection of a revocation trigger. The method may include generating and transmitting to the recipient organization, through the transmission module, a compliance event notification. The monitored organization may be dynamically and authoritatively monitored for adherence to the criteria.

Implementations of credential management methods may include one, all, or any of the following:

Recalibrating, through the compliance criteria module, based on a historical adherence pattern, a threshold of the set of compliance criteria configured to optimize accuracy of future monitoring.

The credential status token may include at least one of a credential verification, a validity period, or a cryptographic signature.

The credential status token may include issue organization-verified recipient organization-specific metadata including at least one of a compliance assessment date, a recipient organization identifier, and a compliance result string.

The credential status token may include a cryptographic signature. The cryptographic signature may use a private key controlled by the credential-defining organization or the issuing organization to form a compliance token that prevents unauthorized duplication of the digital-compliance indicator.

The embedded integration interface module may include at least one of a code snippet configured for direct website integration that renders compliance status data controlled by the credential-defining organization or a plugin configured for automated updating of the digital-compliance indicator configured to block modification by the recipient organization.

The compliance module may be configured to render the compliance indicator in an environment monitored by the recipient organization without granting control or edit access to the recipient organization.

The credential wallet may include a second digital-compliance indicator with digital-compliance-indicator data configured to track progression of compliance over time and executable interface code configured to automatically display digital-compliance indicators on the digital display.

The embedded integration interface may be configured to redirect users who click on the digital compliance indicator to the credential wallet where the credential status token and the digital compliance indicator is displayed and verified.

The credential wallet may maintain a complete audit trail of compliance status changes over time including credential issuance, suspension, revocation, and reactivation events, each cryptographically signed and time-stamped.

Implementations of credential management systems may include a compliance criteria module configured to receive, from a credential-defining organization, a credential, criteria associated with the credential, and an issuing organization associated with the credential. The system may include an issuance module configured to receive, from the issuing organization, an identity of a recipient organization associated with the credential. The system may include a monitoring module configured to continually monitor the organization according to a set of monitored organization actions. The system may include a status token module configured to generate a credential status token and revoke the credential status token upon detection of a revocation trigger. The system may include a compliance module configured to generate a digital compliance indicator corresponding to the credential status token. The system may include a credential wallet configured to store the credential status token and the digital compliance indicator. The system may include a transmission module configured to transmit, in real-time, a credential status notification to an authorized entity. The compliance module may be configured to update, in real-time, a digital display of the recipient organization with the digital-compliance indicator. The system may include a transmission module configured to generate a compliance event notification and transmit the compliance event notification to the recipient organization. The compliance module may be configured to lock the digital-compliance indicator to an issuer-controlled verification key. The organization may be dynamically and authoritatively monitored for adherence to the criteria.

Implementations of credential management system may include one, all, or any of the following:

The system may be configured to maintain unilateral control over activation, suspension, and revocation of digital compliance indicators displayed on a website belonging to the recipient organization.

The embedded integration interface may be configured to redirect users who click on the digital compliance indicator to the credential wallet.

The system may include a distributed verification ledger comprising credential controlled transactions performed by the issuing organization and the credential-defining organization.

The credential status token may include at least one of a credential verification, a validity period, and a cryptographic signature.

The embedded integration interface may include at least one of a code snippet configured for direct website integration that renders compliance status data controlled by the credential-defining organization or a plugin configured for automated updating of the digital-compliance indicator configured to block modification by the recipient organization.

The credential status token may include issue organization-verified recipient organization-specific metadata including at least one of a compliance assessment date, a recipient organization identifier, and a compliance result string.

The revocation trigger may include one of tampering, expired verification data, or data inconsistencies.

The compliance notification event may include a reason for status change, a set of remedial actions, and a set of deadlines associated with the set of remedial actions for corrective action.

Implementations of credential management systems may include a compliance criteria module configured to receive, from a credential-defining organization, a credential, criteria associated with the credential, and an issuing organization associated with the credential. The system may include an issuance module configured to receive, from the issuing organization, an identity of a recipient organization associated with the credential. The system may include a monitoring module configured to continually monitor the organization according to a set of monitored organization actions. The system may include a status token module configured to generate a credential status token and revoke the credential status token upon detection of a revocation trigger. The system may include a compliance module configured to generate a digital compliance indicator corresponding to the credential status token. The system may include a credential wallet configured to store the credential status token and the digital compliance indicator. The system may include a transmission module configured to generate a compliance event notification and transmit the compliance event notification to the recipient organization. The organization may be dynamically and authoritatively monitored for adherence to the criteria.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a schematic of a system for managing credentials coupled to a plurality of external resources;

FIG. 2 is a flow chart illustrating a method of managing credentials;

FIG. 3 is a flow chart illustrating a method of generating a new credential;

FIG. 4 is a flow chart illustrating a method of issuing a credential;

FIG. 5 is a flow chart illustrating a method of generating notifications;

FIG. 6 is a diagram illustrating how credentials are generated and issued;

FIG. 7 is a flow chart illustrating interaction between a credential-defining organization (CDO) and the system for managing credentials;

FIG. 8 is a flow chart illustrating interaction between an issuing organization (IO) and the system for managing credentials;

FIG. 9 is a flow chart illustrating interaction between a recipient organization (RO) and the system for managing credentials;

FIG. 10 is a flow chart illustrating interaction between a credential watcher (CW) and the system for managing credentials;

FIG. 11 is a flow chart illustrating a method of generating a new credential with associated criteria;

FIG. 12 is a flow chart illustrating a method of publishing credentials; and

FIG. 13 is a flow chart illustrating a method of monitoring credential misuse.

### DESCRIPTION

This disclosure, its aspects and implementations, are not limited to the specific components, assembly procedures or method elements disclosed herein. Many additional components, assembly procedures and/or method elements known in the art consistent with the intended credential management systems and related methods will become apparent for use with particular implementations from this disclosure. Unless stated otherwise, as used herein, use of the term “system” refers to a credential management system. Accordingly, for example, although particular implementations are disclosed, such implementations and implementing components may comprise any shape, size, style, type, model, version, measurement, concentration, material, quantity, method element, step, and/or the like as is known in the art for such credential management systems, and implementing components and methods, consistent with the intended operation and methods.

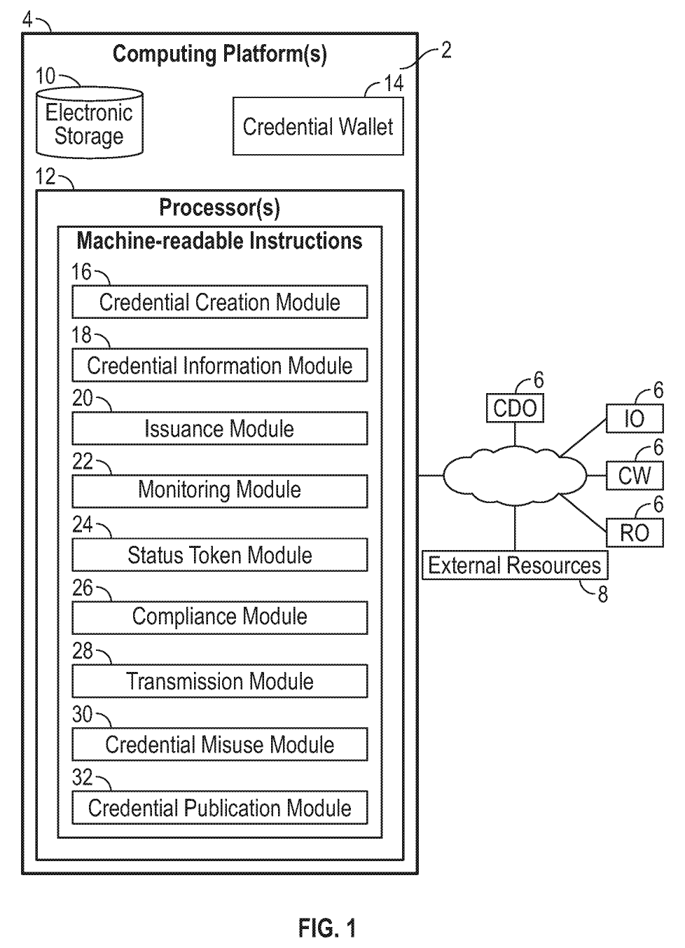

Referring to FIG. 1, a schematic of a credential management system coupled to a plurality of external resources is illustrated, in accordance with one or more implementations. The credential management systems and related methods disclosed herein relate to systems and methods to easily assess and reliably verify the credibility of organizations in the digital credential context. As used herein, a credential is a digital representation of a met criteria, or a compliance adhered to.

In various implementations, the system 2 may be a web-based system configured to run on the web. In various implementations, and as illustrated by FIG. 1, the system 2 may include one or more computing platforms 4 operatively coupled to one or more remote platforms 6. The computing platform(s) 4 may also be operatively coupled to additional external resources 8. The computing platform(s) 4 may serve as a bridge between the operating system or database of the computing platforms and the remote platforms 6 and external resources 8. Computing platform(s) 4 may be configured to communicate with one or more remote platforms 6 according to a client/server architecture, a peer-to-peer architecture, and/or other architectures. Users may access the system 2 via remote platform(s) 6. As used herein, “user” is a term for parties that utilize the system manage or verify credentials. In various implementations, the remote platform(s) 6 may be a computing device. In such implementations, the remote platform(s) 6 may include one or more processors (which may be hardware processors) configured to execute computer program modules. The computer program modules may be configured to enable a user associated with the given remote platform to interface with system 2 and/or external resources 8, and/or provide other functionality attributed herein to remote platform(s) 6. Remote platform(s) 6 may be configured to communicate with other remote platforms via computing platform(s) 4 and/or according to a client/server architecture, a peer-to-peer architecture, and/or other architectures. By way of non-limiting example, a given remote platform and/or a given computing platform may include one or more of a server, a desktop computer, a laptop computer, a handheld computer, a tablet computing platform, a Smartphone, and/or other computing platforms. In particular implementations, computing platform(s) 4 may include a web server. Computing platform(s) 4 may include a plurality of hardware, software, and/or firmware components operating together to provide the functionality attributed herein to computing platform(s). For example, computing platform(s) 4 may be implemented by a cloud of computing platforms operating together as computing platform(s). The computing platform may be securely and operatively coupled to one or more external resources or remote platform(s) through one or more application program interfaces (API).

Still referring to FIG. 1, computing platform(s) 4 may include electronic storage 10, one or more processors 12, and/or other components. Computing platform(s) 4 may include communication lines, or ports to enable the exchange of information with a network and/or other computing platforms. Illustration of computing platform(s) 4 in FIG. 1 is not intended to be limiting.

In various implementations, the electronic storage 10 may include a database. In particular implementations, the electronic storage may also include one or more credential wallets 14 associated with one or more recipient organizations. Each recipient organization may have their own credential wallet. The credential wallets may store a complete audit trail of compliance status changes over time including credential issuance, suspension, revocation, and reactivation events, each cryptographically signed and time-stamped to ensure immutability and traceability.

Electronic storage 10 may comprise non-transitory storage media that electronically stores information. The electronic storage media of electronic storage 10 may include one or both of system storage that is provided integrally (i.e., substantially non-removable) with computing platform(s) 4 and/or removable storage that is removably connectable to computing platform(s) via, for example, a port (e.g., a USB port, a firewire port, etc.) or a drive (e.g., a disk drive, etc.). Electronic storage 10 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 10 may include one or more virtual storage resources (e.g., cloud storage, a virtual private network, and/or other virtual storage resources). Electronic storage 10 may store software algorithms, information determined by processor(s) 12, information received from computing platform(s) 4, information received from remote platform(s) 6, and/or other information that enables computing platform(s) 4 to function as described herein.

Processor(s) 12 may be configured to provide information processing capabilities in computing platform(s) 4. As such, processor(s) 12 may include one or more of a digital processor, an analog processor, a digital circuit designed to process information, an analog circuit designed to process information, a state machine, and/or other mechanisms for electronically processing information. Although processor(s) 12 is shown in FIG. 1 as a single entity, this is for illustrative purposes only. In some implementations, processor(s) 12 may include a plurality of processing units. These processing units may be physically located within the same device, or processor(s) 12 may represent processing functionality of a plurality of devices operating in coordination. Processor(s) 12 may be configured to execute modules (including any modules disclosed herein, including, by non-limiting example, a credential creation module 16, a credential information module 18, an issuance module 20, a monitoring module 22, a status token module 24, a compliance module 26, a transmission module 28, a credential misuse module 30, and a credential publication module 32). Processor(s) 12 may be configured to execute any such modules by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components. In various implementations, multiple modules may share common components.

It should be appreciated that although modules illustrated by FIG. 1 are illustrated as being implemented within a single processing unit, in implementations in which processor(s) 12 includes multiple processing units, one or more of the modules illustrated by FIG. 1 may be implemented remotely from the other modules.

Computing platform(s) 4 may be configured by machine-readable instructions 22. Machine-readable instructions 22 may include one or more instruction modules. Likewise, in implementations where the computing platform(s) include a web server, the web server may also include the one or more instruction modules. The instruction modules may include computer program modules. The instruction modules may include one or more of the credential creation module 16, the credential information module 18, the issuance module 20, the monitoring module 22, the status token module 24, the compliance module 26, the transmission module 28, the credential misuse module 30, the credential publication module 32, and/or other instruction modules.

Still referring to FIG. 1, the remote platforms configured to interact with the credential management system 2 may include any of a credential-defining organization (CDO), and issuing organization (IO), a recipient organization (RO), and a credential watcher (CW). It is understood that reference to these organizations also refers to the computing platforms of these organizations. While the implementations disclosed herein primarily refer to a CDO, IO, RO, and CW, it is understood that the systems and methods disclosed herein may interact with any number of CDOs, IOs, ROs, CWs, credentials, criteria, components, and credential wallets.

The CDO is the organization that sets the foundational rules, requirements, criteria, components, and/or metadata for each credential. The CDO also approves and manages IOs. The CDO owns and updates credential frameworks.

Each credential is composed of one or more criteria which determine the rules for achieving or maintaining the credential. In various implementations, a credential may be static or binary-i.e. either the credential is achieved or it is not. In other implementations, credentials may be dynamic or non-binary and be part of a credential journey, or structured into levels (e.g. bronze, silver, gold) based on combinations of criteria. Such criteria use weighted or threshold evaluation logic. The credential journey may include a series of criteria that show a status change. The change of status may be a progression of accomplishment, a digression of accomplishment, or a regression of accomplishment. For example, a journey may include four different phases. Phase one may include a single criteria being met. Phase two may include two criteria being met, phase three may include three criteria being met, and phase four may include all four criteria being met. In such implementations the credential is not simply earned or not, but includes various statuses associated with stages within the credential journey.

Each criteria is a major requirement within the credential. Criteria may include, by non-limiting example, expiration dates, status rules, or grouping logic. The criteria are made up of one or more components. Components are the most granular unit of verification and may include, by non-limiting example, an individual check, a rule, integration, payment, or file submission. The components may be completed manually, automatically, or both. The components may trigger real-time notifications and status updates when changes occur. Components may be used across multiple criteria and credentials to avoid duplication.

Different organizations may be assigned to particular components, criteria, or credentials. These assignments may be granular and non-inherited. Access to one component does not imply access to others.

The IO is the organization that issues credentials, through the systems disclosed herein, to ROs based on CDO-defined (and optionally IO enhanced) criteria. The IO maintains, through the systems disclosed herein, the ongoing status, expiry, and validity of the credentials. The IO is responsible for verifying that the RO has met and continues to meet the criteria established by the CDO. In various implementations, the IO may also be the CDO. In various implementations, the IO may be the auditor of the RO. In other implementations, the IO may assign auditing rights to a CW.

The RO is the organization that is attempting to receive or maintain the credential established by the CDO (or IO in particular implementations). They are monitored by the IO through the systems disclosed herein to verify that the credential earned is valid. The RO may display credentials via an embedded code.

The CW is any organization or entity that has a vested interest in knowing and monitoring the live status of credentials across one or more ROs. The CWs may be assigned by the ROs. In other implementations, the CWs may be assigned by an IO or CDO. The CWs may be, by non-limiting example, contractors, regulators, auditors, law firms, or partners. As an example, a legal firm may be a CW monitoring adherence to specific criteria and credentials of a client for securing a government contract.

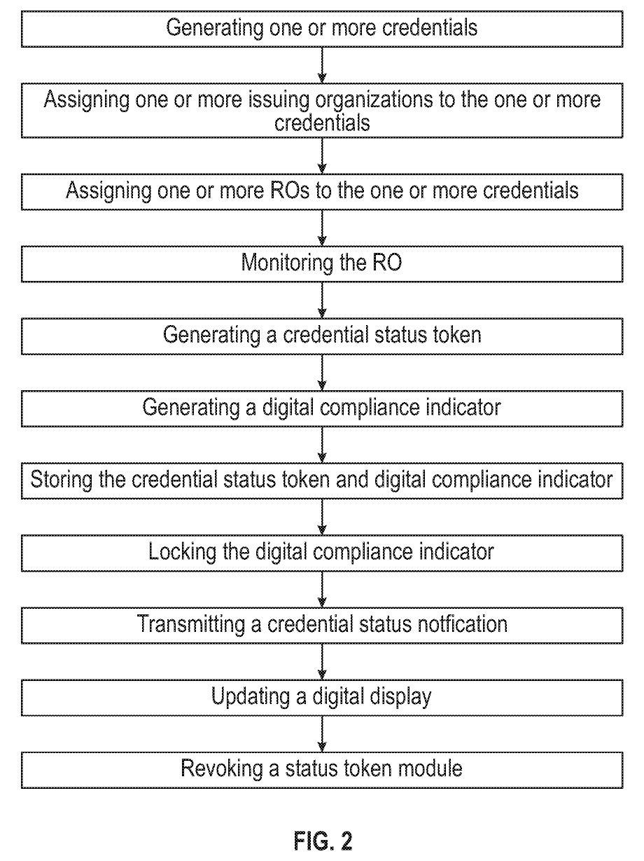

Referring to FIG. 2, a flow chart illustrating a method of managing a credential is illustrated. The credential system 2, and any elements thereof, are configured to practice the associated methods, and elements thereof, disclosed herein.

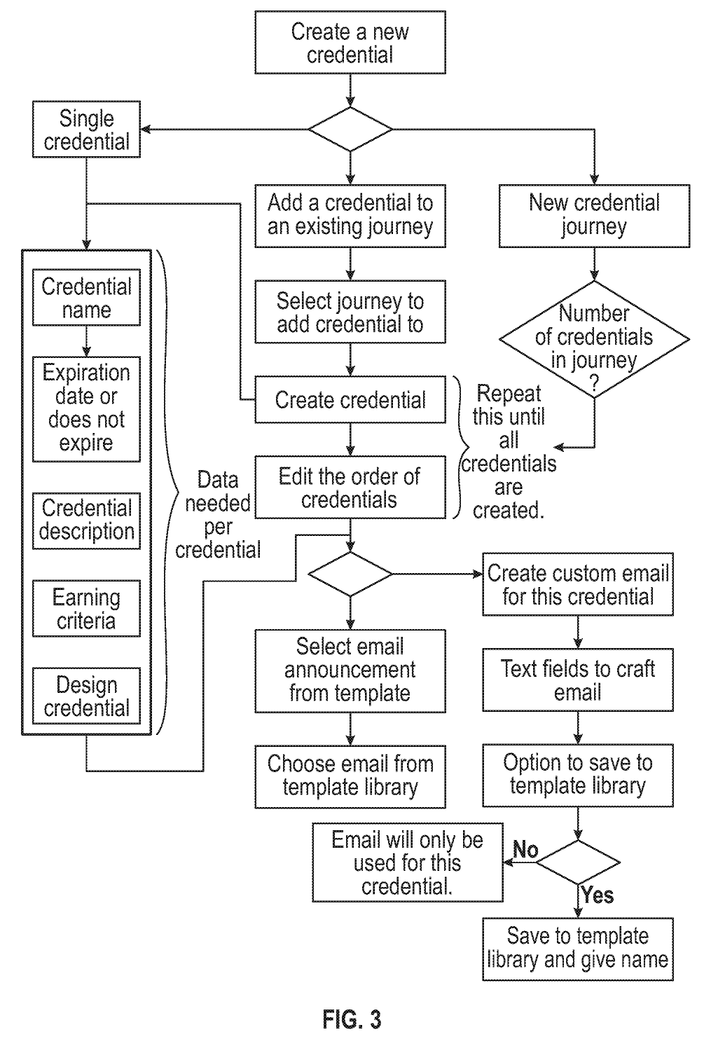

The method of managing credentials may include generating, through a credential creation module, a credential and criteria associated with the credential. Referring to FIG. 3, a flow chart illustrating a method of generating a new credential is illustrated. In various implementations, the new credential may be generated by a CDO through the credential creation module. A stand-alone, single credential may be created, a new credential may be created and added to an existing credential journey, or a new credential journey may be created through the credential creation module.

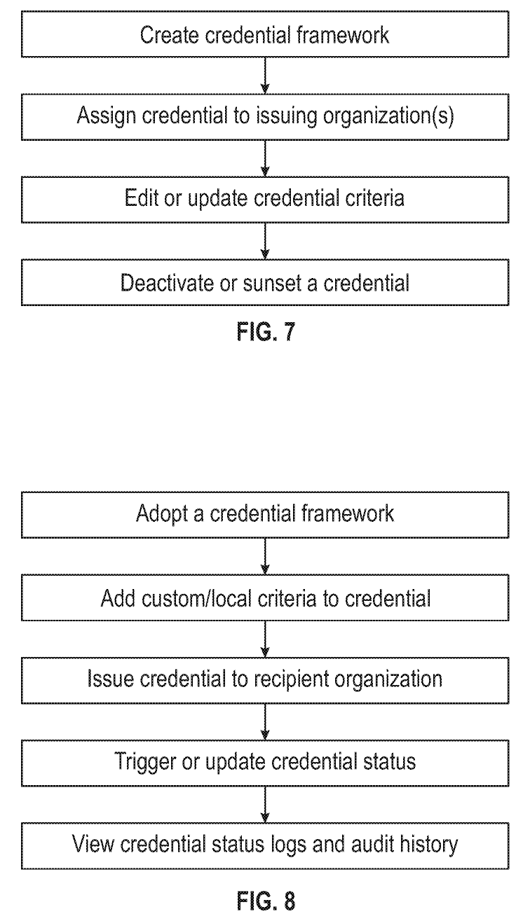

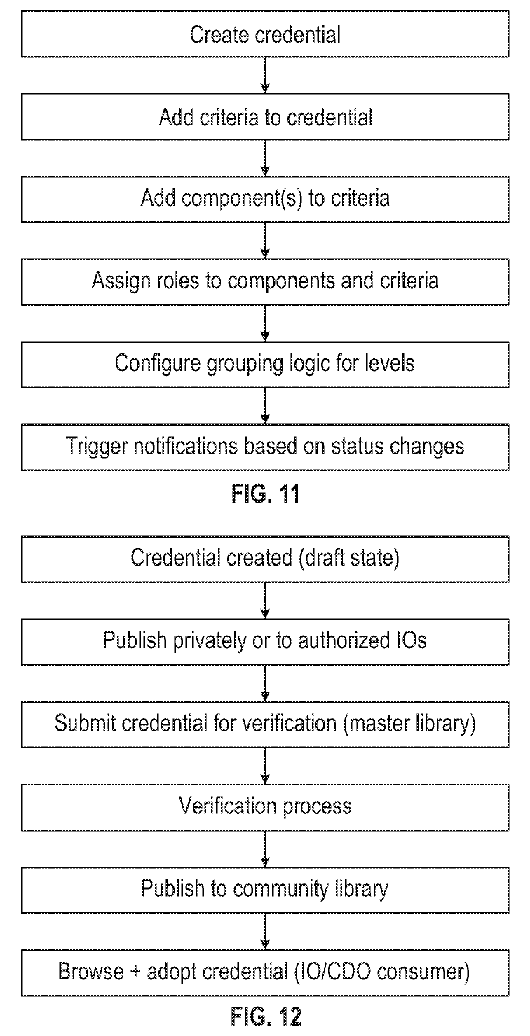

Referring to FIG. 7, a flow chart illustrating interaction between a CDO and the credential management system is illustrated. Referring to FIG. 11, a flow chart illustrating a method of generating a new credential with associated criteria is illustrated. Referring to both FIGS. 3, 7, and 11 the CDO may create a credential framework and the credential creation module may receive corresponding input data from a CDO. The input data may include, by non-limiting example, the credential name, credential description, a credential expiration date, criteria, visibility settings, category tags, and a visual design for the digital credential indicator. This framework may be saved in the credential management system as a template that the CDO may assign to IOs.

The credential creation module may generate a unique credential ID, validate any required fields where the CDO needed to input data, and stores the new credential in a credential registry within the electronic storage.

Referring to FIG. 11, in various implementations the method of creating a credential may include adding criteria to the credential. In such implementations, the method may include receiving, at the credential creation module, from a CDO, any of a criteria name, description, expiration rules, a weight or grouping logic (if the criteria is used in levels). The credential creation module may then assign the criteria an ID, update or create a credential and criteria structure tree, and allow component creation.

Still referring to FIG. 11, in various implementations the method of creating a credential may include adding components to the criteria. In such implementations, the method may include receiving, at the credential creation module, from a CDO, any of a component name, description, expiration rules, a weight or grouping logic (if the component is used in levels). The credential creation module may then assign the component an ID, and update or create the credential and criteria structure tree.

As illustrated by FIG. 11, the method of generating a credential may include configuring grouping logic for levels or credential journeys. In such implementations, the credential creation module may receive, from a CDO (or in some implementations, an IO), grouped criteria, the logic type, and the level names. The credential creation module may then display the visual grouping and enable level evaluation in live credentials. In various implementations, the system may apply the logic to an evaluation engine within the monitoring module.

Referring back to FIG. 3, in implementations where the credential is to be added to an existing journey, the method may include selecting the journey the credential is to be added to through the credential creation module and then creating the credential. The order of criteria within a credential journey may also be edited within the credential creation module.

In implementations where a new credential journey is to be created, the method may include receiving journey data within the credential creation module such as, by non-limiting example, the number of criteria within the credential journey, the name of the journey, and a description of the journey. The method may then include creating criteria within the credential journey which may be done the same way criteria for a credential that is not part of a journey is created.

The method of generating the credentials may include creating an email or notification template associated with the criteria of the credential. The template may be saved. In other implementations, the template is not saved but may be used just for the single criteria a single time. While the system and associated methods contemplates the use of emails for notifications, it is understood the system and related methods may use other types of communications for any communication element of the system or method, including, by non-limiting example, peer-communication platforms, text messaging, or an organization communication system.

In other implementations, rather than the credential management system creating a credential, the method may include receiving, from the CDO, through a credential information module, criteria corresponding with a credential. In such implementations, the CDO previously created the credential and is submitting it to the credential management system rather than creating the credential through the credential management system.

Referring back to FIG. 2 and FIG. 7, in various implementations, the method of managing a credential may include assigning one or more IOs to the one or more credentials. In such implementations, the credential information module may receive, from a CDO, an identity of an IO associated with the credential, or permitted to issue the credential. The CDO may input a credential ID, an IO account ID, and assignment setting (such as editing permissions) into the credential information module. The credential information module may then send a notification (alone or through the transmission module disclosed herein) to the IO that it has been assigned to a particular credential. The credential information module may log the assignment of the IO to the credential.

Referring back to FIG. 7, the CDO may edit or update credential criteria through either the credential creation module or the credential information module. In such implementations, the CDO may update criteria, components, rules, or any other piece of data associated with the credential. The credential creation module or the credential information module may then notify the affected IOs and flag any dependent criteria with a warning. Notification to the IOs may include a description of the update, an expected implementation date, and what needs to be done to meet the criteria and maintain the credential.

The CDO may also deactivate or sunset a credential through the credential creation module or the credential information module. In such implementations, the CDO may indicate the credential ID to be deactivated. The credential management system may then notify all linked IOs and ROs, flag the credential as “expired,” and prevent future issuance.

Referring to FIG. 8, a flow chart illustrating interaction between an issuing organization (IO) and the credential management system is illustrated. In various implementations, the method of generating a credential may include an IO adopting a credential framework. In such implementations, the credential information module may copy the framework and store it within the IOs active inventory.

In various implementations, the method may include adding criteria or components from an IO to the credential through the credential creation module. In such implementations, the credential creation module may store the additional logic from the IO separately so the base credential created by the CDO is not altered. Unless they are one in the same, the IO cannot alter the existing criteria and components of credentials established by a CDO, however, they can add additional criterial or components to the credential. The credential management system may also flag downstream recipients of the customizations by the IO.

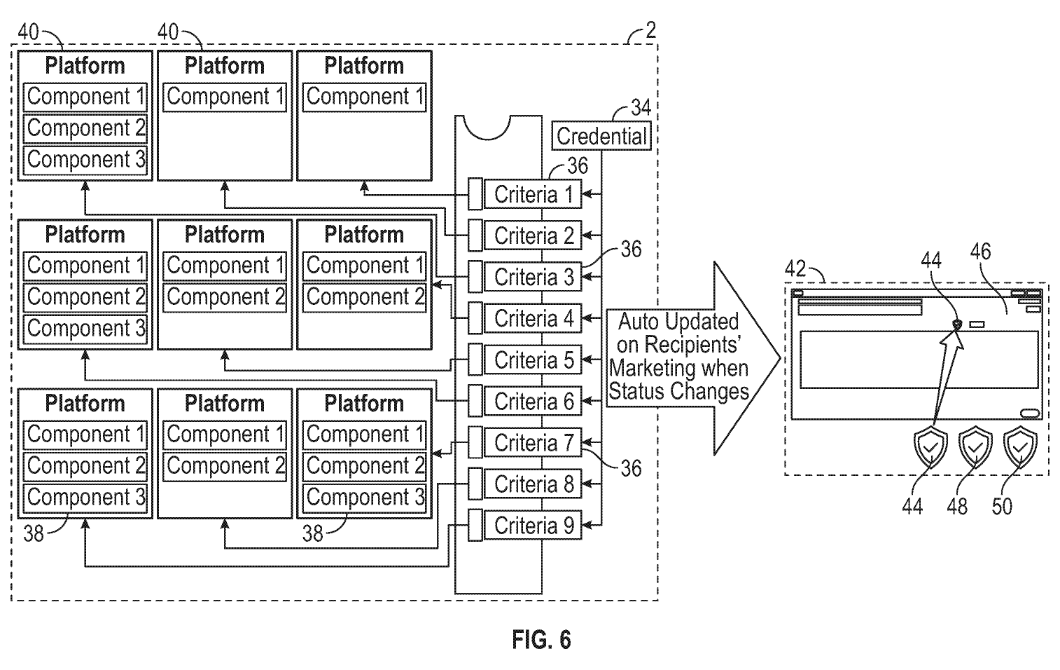

Referring to FIG. 6, a diagram of the generation and issue of credentials is illustrated. The credential management system 2 may includes a credential 34 tied to a plurality of criteria 36. Each criteria is made from one or more components 38. Each component may be assigned to a platform 40 where the component can be monitored.

In various implementations, the credential may be an organizational membership credential. Components of criteria for the membership may include a payment or completion of continuing education. (such as, by non-limiting example, a student organization, a professional organization, Vendor, Local Chapter Level, National Chapter Level, and International Chapter Level). The credential may be used to illustrate earned membership related criteria. The credential management system may ensure that membership is represented accurately.

In various implementations, the credential may be an award credential. The criteria may include a payment verification, the application submission, or any other criteria that needs to be submitted for consideration. This award is issued to the RO, not an individual within or associated with it. For example, a city may release a list of best places to work every year. If an RO wants to be awarded this recognition, they would have to pay an associated fee, fill out an application, and complete other associated criteria.

In various implementations, the credential may be partnership credential that can indicate partnerships across different organizations. Partner programs may include multiple categories of partners. Each category may include a different set of criteria that needs to be met. Within each of these four categories, a partner can specialize even further into sub-categories. Some partner programs have expiration dates on their certifications, which will also be monitored and displayed accordingly in the digital wallet. Each credential corresponds to categories, sub-categories, and or/certifications that partners have earned, received, or are qualified to practice or implement.

In various implementations, the credential may be a cybersecurity credential establishing that an organization complies with a certain security standard. Any of the credentials herein may also include security related criteria or components.

Various organizations may each include its own security compliance standards, making it essential to track adherence or compliances to these requirements. The adherence of each criteria for each credential may be determined by an IO through the credential managements system 2, which may award corresponding credentials to the RO 42.

The method of managing credentials may include publishing credentials through a credential publication module after the credentials are generated. In various implementations, a CDO may indicate what IOs the credential should be published for. In such implementations, the credential publication module may create visibility tokens associated with the credentials to be published and send publication notifications to the indicated IOs. In various implementations, the level of account access will determine the level of detail and visibility to status changes. For example, public access to information could be the current level and dates of change of status. An RO and IO may receive detailed information as to what changed, when it changed, and any actions that need to be done. A CW may receive change of status notifications relevant to them and what, if any, action needs to be taken. In other implementations, the system may publish credentials according to the method illustrated by FIG. 12.

In other implementations, the CDO may request to the credential publication module that the credential be published in the credential management system’s master library. In such implementations, the credential publication module may conduct a review of the credential to ensure it is complete and approved by the credential management system. The credential publication module may then add the credential to the community library where it may be searched by the public. Once in the community library, any CDO or IO may browse through the library and adopt credentials by selecting credentials for use by the CDO or IO.

In various implementations, the CDO may request to the credential publication module that a credential created by the CDO be removed from the credential management system’s master library or that a particular IO not have the ability to adopt the credential.

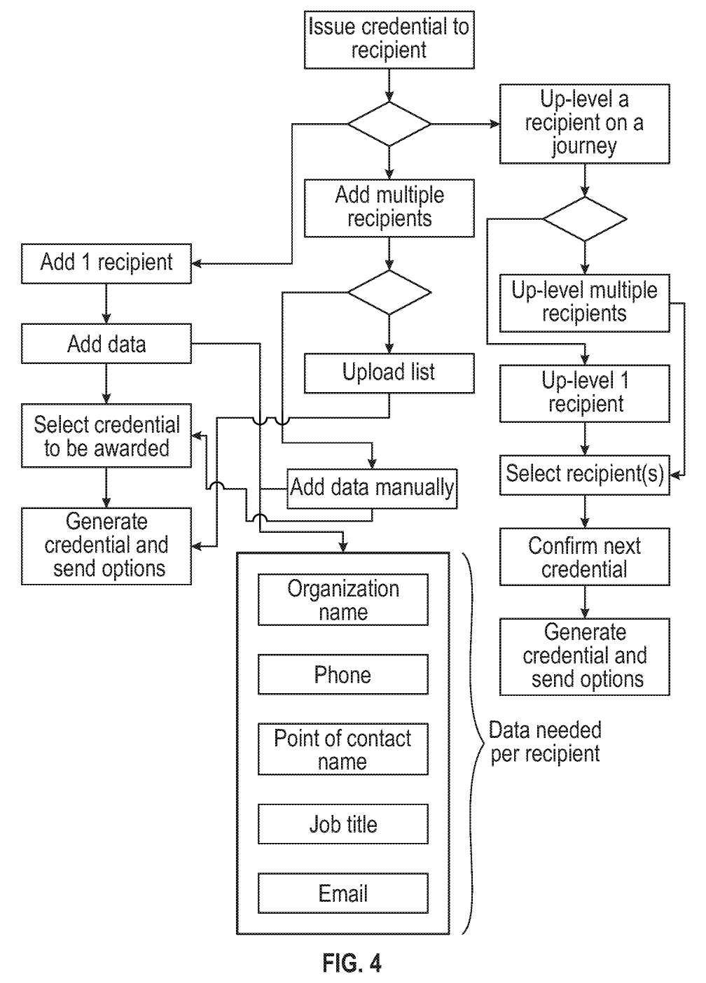

Referring back to FIG. 2, the method of managing a credential may include, receiving, at an issuance module, from the IO, an identity of an RO associated with the credential. Referring to FIG. 4, a flow chart of a method of issuing a credential is illustrated. The IO may be configured to enter information for each recipient into the issuance module, including but not limited to enterprise name, point of contact (or multiple point of contacts) name , job title, and email address. Further, the method may include initiating the issue of a credential by enabling the IO to select between adding a single RO or multiple ROs. The IO may select from a list of available credentials or predefined credential journeys, specifying the credentials to be awarded. This selection of ROs is based on a predefined criteria for credential eligibility, (which exceeds a compliance threshold) which, once met, the IO triggers the automatic dispatch of the credential through the issuance module. In various implementations, the system may also embed permissions for where the credential can be displayed. The issuance module may link the credential with the RO assigned to the credential by the IO. In various implementations, the issuance module may link a credential with multiple ROs assigned to that credential.

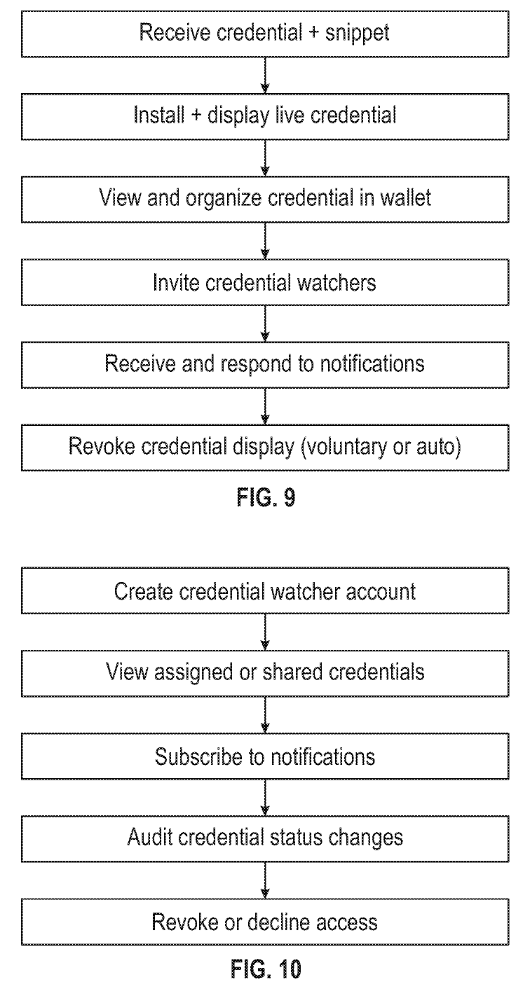

Referring back to FIG. 2, in various implementations the method of managing a credential includes assigning one or more CWs to an RO. This assignment may be done by receiving an identity of one or more CWs from the RO. Referring to FIG. 9, a flow chart illustrating interaction between an RO and the credential management system is shown. CWs may be assigned by the RO by inputting identifying information of the CW or an account ID for the CW to the credential management system. The RO can also indicate which credentials they would like shared with the CW. The credential management system may then send a notification to the CW that they have been assigned as a CW for a particular RO and associated credential or credentials.

Referring to FIG. 10, a flow chart illustrating interaction between a CW and the credential management system is illustrated. In various implementations, the CW may create an account and then view assigned or shared credentials of particular ROs. The CW may be able to subscribe to compliance notifications from the transmission module and audit credential status changes. The CW has the option of revoking or declining access so they are not notified or have access to the private credentials of a particular RO.

Referring back to FIG. 2, the method of managing a credential may include continually monitoring, through a monitoring module, the RO according to a set of monitored organization actions associated with components and/or criteria of a credential. Monitored organization actions could be various activities, transactions, or systems associated with platforms of components included in the criteria. For example, the monitoring module may monitor a payment platform to see if an RO met the criteria of paying a subscription fee. The monitoring module may monitor the RO (and any associated platforms of the RO) to determine if any of the credentials (and associated criteria and components) have been earned, lost, or undergone a status change (by, for example, changing levels within a journey).

In various implementations, the monitoring module may connect to third party systems to validate compliance for criteria and the resulting credentials. In various implementations, the monitoring module may utilize live audit technology configured to continuously check and/or validate compliance adherence in real-time without manual intervention.

In implementations having weighted and dynamic based credentials, the monitoring module may dynamically monitor an RO for adherence to the set of compliance criteria and thresholds associated with the criteria.

In various implementations, the monitoring module may be configured to continually monitor the ROs compliance for different credentials. Live monitoring may be customized relevant to the criteria and components. For example, if there is a year expiration and nothing else needs to be monitored, this criteria may be checked annually. Other criteria may be checked quarterly, monthly, bi-monthly, weekly, daily, hourly, or every minute. In other implementations, continuous monitoring may include monitoring more frequently than every 60 seconds. Continuous monitoring ensures a live audit of criteria to provide an accurate real-time snapshot of an ROs compliance for certain credentials.

Still referring to FIG. 2, the method of managing a credential may include generating, through a status token module, a credential status token. The status token module receives instructions to generate, revoke, or update a particular status token based upon the static or dynamic criteria set forth by the CDO and/or IO and the monitoring of the RO and associated platforms by the monitoring module. The credential status token represents the IO’s intent as irrevocable trust or veracity of an earned credential as it is verified by the credential management system. The credential status token may include at least one of (and may include more than one of) a credential verification, a status change, a validity period, or a cryptographic signature. In certain embodiments, the token is cryptographically immutable and issuer authoritative. The token comprises (i) a payload, (ii) issuer metadata describing issuance criteria and intent, and (iii) a cryptographic integrity marker generated by the issuing authority (e.g., a payload hash signed with the issuer’s private key). In some embodiments, the issuer-signed token and/or its signature are recorded in an append-only ledger or write-once audit log, and the ledger entry is time-stamped, thereby providing tamper-evidence, non-repudiation, and a persistent record that the issuing authority generated the token under the stated criteria. The issuer may retain exclusive control over issuance criteria and keying material and may publish a revocation or status service to indicate tokens that were revoked or superseded after issuance.

The status token module may use a cryptographic signature associated with a qualified assessor's private key or a private key controlled by CDO or IO to form the credential status token that prevents unauthorized duplication of the digital-compliance indicator.

In various implementations, the status token may include RO specific metadata verified by the IO through the credential management system. The metadata may include at least one of (but may include more than one of) a compliance assessment date, an RO identifier, and a compliance result string.

In implementations having dynamic, or weighted credentials, the status token module may generate different types of status tokens corresponding to different levels within a credential journey. The status token module may also revoke a status token upon detection of a revocation trigger.

Still referring to FIG. 2, in various implementations the method of managing a credential includes generating, through a compliance module, a digital compliance indicator corresponding to the credential status token. The digital compliance indicator may include a compliance status with a compliance indicator, a non-compliance status with a non-compliance indicator, or a particular compliance level status with a corresponding particular compliance level indicator. The compliance indicator is a visual indication of the credential that may be displayed on a digital display associated with the RO. Digital displays may include, by non-limiting example, web pages, apps, digital signs, or any other digital display.

An example of a digital compliance indicator 44 on a digital display 46 (in this case, a webpage) is illustrated by FIG. 6. The compliance indicator may be replaced with a non-compliance indicator 50 or a different type of digital compliance indicator 48 based upon changes to the status token. While not illustrated by FIG. 6, visual characteristics of each digital compliance indicator may be different (thus, the visual characteristics between a compliance indicator and a non-compliance indicator are readily ascertainable). The digital compliance indicators may be automatically presented on the digital display to indicate compliance or compliance failure and to prevent concealment or alteration by the RO.

In various implementations, the method of managing a credential may include generating, through the compliance module, a second digital-compliance indicator with digital-compliance-indicator data configured to track progression of compliance over time. The compliance module may be configured to generate any number of digital compliance indicators and present them on a digital display.

In various implementations, the method of managing a credential may include storing the credential status token and the digital compliance indicator in a credential wallet configured to automatically and in real-time synchronize with a digital display. The credential wallet may belong to a particular RO (the credential management system has separate credential wallets for each RO). The digital display is synchronized with the credential wallet as the compliance module and status token module send updated compliance information, in real-time, to both the credential wallet and the associated digital display.

In various implementations, the compliance module includes an embedded integration interface. The embedded integration interface may lock a digital compliance indicator with an IO controlled verification key. The embedded integration interface may also include a code snippet or plugin configured for direct website (or other digital display) integration that renders compliance status data controlled by the CDO or IO, and automatically updates the digital-compliance indicator on the digital display while blocking any modification to the digital compliance indicator by the recipient organization. The snippet or plugin may be received from the IO and transmitted to the RO through the compliance module rather than the RO receiving a static image of the credential. The RO has read-only access to the digital compliance indicator. In turn, the digital compliance indicator, or evidence that a particular credential was obtained or lost, remains cryptographically signed and verifiable exclusively by the CDO or IO. Falsification, tampering, and/or unauthorized suspension of credential status is avoided through continuous monitoring and real-time, automatic updating via the compliance module.

In various implementations, the embedded integration interface is configured to redirect users who click on the digital compliance indicator to the secure credential wallet where the credential status token and the digital compliance indicator are displayed and verified directly by the credential management system to ensure authenticity and prevent RO redirection or manipulation.

Still referring to FIG. 2, the method of managing a credential includes generating and transmitting to the RO, IO, CW and/or any other authorized parties, through a transmission module, a credential status notification. The credential status notification may be generated and sent in real-time upon the detection of a credential being earned, revoked, or the status of the credential changing.

The transmission module may send multiple credential status notifications upon the detection of a credential being earned, revoked, or the status of the credential changing. Each notification may have content tailored for the particular recipient, providing role-based context for compliance status changes. For example, the transmission module may send a first credential status notification to the corresponding RO. This notification may include a reason for the compliance status change, a set of remedial actions, and a set of deadlines associated with the set of remedial actions for corrective action. Other notifications, such as notifications to a CW, may just include an indication that the status changed without any additional details as to why the status changed. The level of detail associated with a notification may vary and may be less for a CW than the level of detail associated with a notification sent to an IO, RO, or CDO.

The credential status notifications may include cryptographically signed verification data to confirm the authenticity of the notification. The credential status notifications may include timestamps generated by the credential management system to further verify the credential status notification.

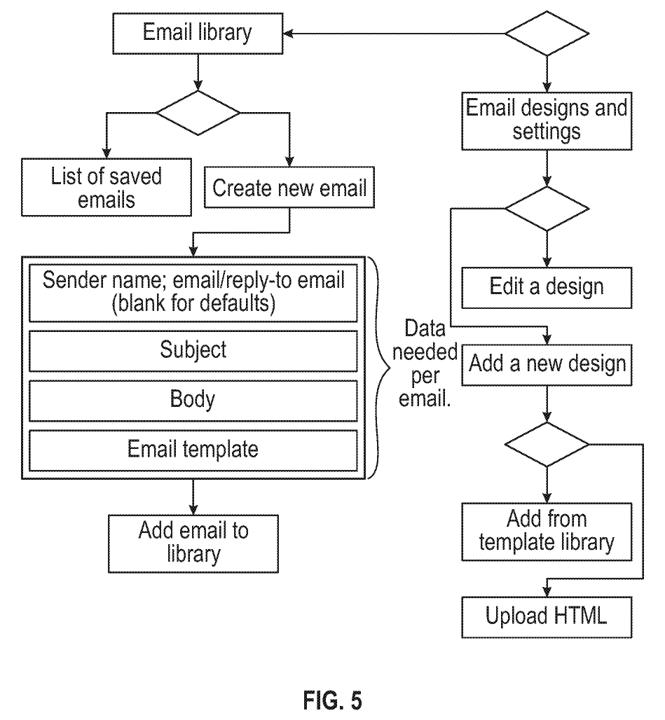

In various implementations, the credential status notification may be generated from a library of template notifications. Referring to FIG. 5, a flow chart illustrating a method of generating notifications and notification templates is illustrated. While FIG. 5 specifically mentions emails, it is understood that the process illustrated by FIG. 5 may be used for other types of communications, including, by non-limiting example, peer-communication platforms, text messaging, or an organization communication system. The method may include creating a new notification with particular data, such as a subject, sender name, recipient, and body language and also creating a new template for the design of the notification.

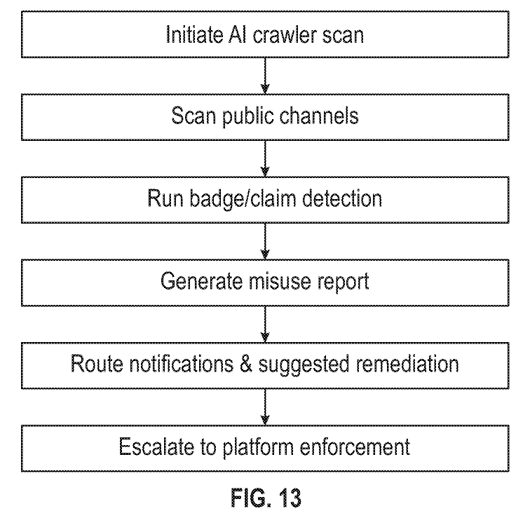

In various implementations, the credential management system may include a credential misuse module. Referring to FIG. 13, a flow chart for a method of monitoring credential misuse is illustrated. In various implementations, the credential misuse module may include, or at least utilize artificial intelligence to scan, or crawl, for misuse of credentials. The method may include initiating the scan by inputting the credential IDs and/or the credential visual designs to be scanned for. The method may include inputting RO domains, brand names belonging to the RO. In other implementations, particular ROs may not be identified but the method may include scanning all the different organizations on the web. The credential misuse module may then upload the relevant information into the AI crawler which will then scan public channels. The AI crawler may scan the text and images of the public channels to find matches of the credentials in the public channels. Upon finding a match, the credential misuse module may compare the credential displayed in the public channel against what is stored in the ROs credential wallet. If the RO is displaying a credential that they are not authorized to display by working outside of the credential management system, the credential misuse module may detect this unauthorized use and notify the CDO or IO. In various implementations, the credential misuse module may also notify the RO of the infraction. The credential misuse module may also communicate to the RO how to remedy the infraction or consequences if the infraction is not remedied. In implementations where use of a credential by an organization that is not listed as an RO is found, the credential misuse module may report such use to the CDO.

In various implementations, the credential management system may revoke active credentials or disable features available to the ROs within the system based upon violations. This punitive action may further dissuade ROs from tampering with or displaying counterfeit credentials outside of the credential management system.

In various implementations, the credential misuse module may calculate a trust score based on the number of violations, a history of misuse or enforcement, and the amount of time it takes for the RO to resolve the violations. ROs may receive an overall score—tracking how they maintain all credential criteria overtime and a per-credential score. The trust score may be available to the public. The credential misuse module may also include verified compliance APIs for regulators, procurement teams, and contracting authorities. The trust score in conjunction with the API may help different parties interested in working with the RO to determine whether they are a high risk for non-compliance. The trust score may increase market pressure (at least from the perspective of landing contracts) to ROs to use credentials properly and to stay compliant. In various implementations, the credential misuse module may track a history of misuse along with an associated trust score that may be viewable by the associated IO.

In various implementations, the monitoring module may be configured to recalibrate monitoring methods of ROs based upon the historical adherence pattern, risk score, or trust score. Based upon this recalibration, various thresholds for various criteria may be altered or optimized to improve the accuracy of future monitoring.

The credential management system may employ a distributed verification ledger that records credential control transactions performed by the CDO, IO, RO, and the credential management system, ensuring auditability, immutability, and traceability of enforcement actions and credential lifecycle events.

In places where the description above refers to particular implementations of credential management systems and implementing components, sub-components, methods and sub-methods, it should be readily apparent that a number of modifications may be made without departing from the spirit thereof and that these implementations, implementing components, sub-components, methods and sub-methods may be applied to other credential management systems and related methods.

What is claimed is:

1. A credential management method, comprising:
receiving, from a credential-defining organization, through a credential information module, a criteria corresponding with a credential;
receiving, from a credential-defining organization, through a credential information module, an identity of a issuing organization associated with the credential;
receiving, at an issuance module, from the issuing organization, an identity of a recipient organization associated with the credential;
continually monitoring, through a monitoring module, the recipient organization according to a set of monitored organization actions associated with the criteria;
generating, through a status token module, a credential status token;
generating, through a compliance module, a digital compliance indicator corresponding to the credential status token, wherein the digital compliance indicator comprises one of:
a compliance status with a compliance indicator operatively associated therewith; or
a non-compliance status with a non-compliance indicator operatively associated therewith;
storing the credential status token and the digital compliance indicator in a credential wallet configured to automatically and in real-time synchronize with a digital display;
transmitting, through a transmission module, a credential status notification in real-time to the receiving organization;
in real-time updating, via an embedded integration interface comprised in the compliance module, the digital display with a digital-compliance indicator;
upon failure of the recipient organization to adhere to the criteria, automatically replacing the compliance status with the non-compliant status on the digital display;
locking, through the compliance module, the digital-compliance indicator to an issuer-controlled verification key; and
revoking, through the status token module, the credential status token upon detection of a revocation trigger;
wherein the receiving organization is dynamically and authoritatively monitored for adherence to the criteria.

2. The credential management method of claim 1, further comprising recalibrating, through the compliance criteria module, based on a historical adherence pattern, a threshold of the set of compliance criteria configured to optimize accuracy of future monitoring.

3. The credential management method of claim 1, wherein the credential status token comprises at least one of a credential verification, a validity period, or a cryptographic signature.

4. The credential management method of claim 1, wherein the credential status token comprises:
Issue organization-verified recipient organization-specific metadata including at least one of:
a compliance assessment date;
a recipient organization identifier; and
a compliance result string.

5. The credential management method of claim 1, wherein the credential status token comprises a cryptographic signature, wherein the cryptographic signature uses a private key controlled by the credential-defining organization or the issuing organization to form a compliance token that prevents unauthorized duplication of the digital-compliance indicator.

6. The credential management method of claim 1, wherein the embedded integration interface comprises at least one of:
a code snippet configured for direct digital display integration that renders compliance status data controlled by the credential-defining organization; or
a plugin configured for automated updating of the digital-compliance indicator configured to block modification by the recipient organization;
wherein the digital display is a website.

7. The credential management method of claim 1, wherein the compliance module is configured to render the compliance indicator in an environment monitored by the recipient organization without granting control or edit access to the recipient organization.

8. The credential management method of claim 1, wherein the credential wallet comprises:
a second digital-compliance indicator with digital-compliance-indicator data configured to track progression of compliance over time; and
executable interface code configured to automatically display digital-compliance indicators on the digital display.

9. The credential management method of claim 1, wherein the embedded integration interface is configured to redirect users who click on the digital compliance indicator to the credential wallet where the credential status token and the digital compliance indicator is displayed and verified.

10. The credential management method of claim 1, wherein the credential wallet maintains
a complete audit trail of compliance status changes over time including credential issuance, suspension, revocation, and reactivation events, each cryptographically signed and time-stamped.

11. A credential management system comprising:
a compliance criteria module configured to receive, from a credential-defining organization, a credential, criteria associated with the credential; and an issuing organization associated with the credential;
an issuance module configured to receive, from the issuing organization, an identity of a recipient organization associated with the credential;
a monitoring module configured to continually monitor the organization according to a set of monitored organization actions;
a status token module configured to generate a credential status token and revoke the credential status token upon detection of a revocation trigger specific to the recipient organization;
a compliance module configured to generate a digital compliance indicator corresponding to the credential status token;
a credential wallet configured to store the credential status token and the digital compliance indicator;
a transmission module configured to transmit, in real-time, a credential status notification to an authorized entity;
an embedded integration interface configured to update, in real-time, a digital display of the recipient organization with the digital-compliance indicator; and
a transmission module configured to generate a compliance event notification and transmit the compliance event notification to the recipient organization;
wherein the compliance module is configured to lock the digital compliance indicator to an issuer-controlled verification key;
wherein the organization is dynamically and authoritatively monitored for adherence to the criteria.

12. The credential management system of claim 11, wherein the system is configured to maintain unilateral control over activation, suspension, status changes, and revocation of digital compliance indicators displayed on the digital display of the recipient organization.

13. The credential management system of claim 11, wherein the embedded integration interface is configured to redirect users who click on the digital compliance indicator to the credential wallet.

14. The credential management system of claim 11, wherein the system comprises a distributed verification ledger comprising credential controlled transactions performed by the issuing organization and the credential-defining organization.

15. The credential management system of claim 11, wherein the credential status token comprises at least one of:
a credential verification;
a validity period; and
a cryptographic signature.

16. The credential management system of claim 11, wherein the embedded integration interface comprises at least one of:
a code snippet configured for direct digital display that renders compliance status data controlled by the credential-defining organization; or
a plugin configured for automated updating of the digital compliance indicator configured to block modification by the recipient organization.

17. The credential management system of claim 11, wherein the credential status token comprises:
Issue organization-verified recipient organization-specific metadata including at least one of:
a compliance assessment date;
a recipient organization identifier; and
a compliance result string.

18. The credential management system of claim 11, wherein the revocation trigger comprises one of:
tampering;
expired verification data; or
data inconsistencies.

19. The credential management system of claim 11, wherein the compliance event notification comprises:
a reason for status change;
a set of remedial actions; and
a set of deadlines associated with the set of remedial actions for corrective action.

20. A credential management system comprising:
a compliance criteria module configured to receive, from a credential-defining organization, a credential, criteria associated with the credential; and an issuing organization associated with the credential;
an issuance module configured to receive, from the issuing organization, an identity of a recipient organization associated with the credential;
a monitoring module configured to continually monitor the organization according to a set of monitored organization actions;
a status token module configured to generate a credential status token and revoke the credential status token upon detection of a revocation trigger;
a compliance module configured to generate a digital compliance indicator corresponding to the credential status token;
a credential wallet configured to store the credential status token and the digital compliance indicator; and
a transmission module configured to generate a compliance event notification and transmit the compliance event notification to the recipient organization;
wherein the organization is dynamically and authoritatively monitored for adherence to the set of compliance criteria.
